(19) United States
(12) Patent Application Publication
(10) Pub. No.: US 2002/0160791 A1
(43) Pub. Date: Oct. 31, 2002

(54) Cellular attachable cordless telephone

(76) Inventor: Ronald A. Markowitz, Armonk, NY (US)

Correspondence Address: Ronald A. Markowitz, 1 Byram Brook Place, Armonk, NY, 10504, US

(21) Appl. No.: 09/809,959

(22) Filed: Mar. 16, 2001

(51) Int. Cl. H04M 1/00

(52) U.S. Cl. 455/462; 455/554; 455/569; 455/552; 455/426

(57) ABSTRACT

An integrated cordless telephone base station containing a receptacle for a cellular telephone, having circuitry enabling a cellular call to be transmitted between the said base station and remote cordless handset transceivers using cordless telephone radio frequencies. Whenever a portable cellular telephone is placed into, or docked with, the cordless telephone base station, cellular telephone calls can be received and made using the cordless telephone handset transceiver. The cellular telephone can be removed from the said base station for regular use whenever the user needs to leave the range of the cordless transceiver. This device allows the use of a cordless telephone without the need to be connected to a wired telephone land-line.

### CROSS REFERENCE TO RELATED APPLICATIONS

| Application # | Application Date | Pat. # | Issued Date | Title |
|---|---|---|---|---|
| US199600730642 | Oct. 11, 1996 | S5953651 | Sep. 14, 1999 | Cellular adjunct to a public |
| US1987000007613 | Jan. 28, 1987 | S4776000 | Oct. 4, 1998 | Telephone communications |
| | | | | systems with portable |
| | | | | handsets |
| US1997000865618 | May 30, 1997 | S5999823 | Dec. 7, 1999 | Cellular cordless telephone |
| US1993000160135 | Dec. 2, 1993 | S5550895 | Aug. 27, 1996 | Bimodal portable telephone |
| US1994000258353 | Jun. 10, 1984 | S5513248 | Apr. 30, 1996 | Cordless telephone micro- |
| | | | | cellular system |
| 203711 | Feb. 28, 1994 | 5367558 | Nov. 22, 1994 | Cellular cordless telephone |
| US1988000249041 | Sep. 23, 1988 | US4989230 | Jan. 29, 1991 | Cellular cordless telephone |
| US199800128936 | Aug. 5, 1998 | US6151387 | Nov. 21, 2000 | Telephonic-interface game |
| | | | | control system |
| US1997000865618 | May 30, 1997 | S5999823 | Dec. 7, 1999 | Cellular cordless telephone |
| US1987999997613 | Jan. 28, 1987 | S4776000 | Oct. 4, 1988 | Telephone communications |
| | | | | systems with portable |
| | | | | handsets |
| US1984000674339 | Nov. 23, 1984 | S4634810 | Jan. 6, 1987 | Station for the |
| | | | | accommodation of |
| | | | | chargeable cordless |
| | | | | telephone |
| US1989000294429 | Jan. 6, 1989 | S4881259 | Nov. 14, 1989 | Answering machine with |
| | | | | cordless telephone |

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The technical field of the present invention is generally related to cellular telephones and more particularly to an improved cordless telephone for providing use of the cordless telephone with or without the need of a wire land-line connection.

In the prior art, cordless telephones typically are used in the home to allow the user to place and receive telephone calls at any point throughout the house. Such cordless telephones are connected to external telephone networks by wire land-line. However, when a user leaves the home he typically takes a portable cellular telephone to connect to a wireless telephone network. This becomes inconvenient to anyone trying to reach the user by telephone. If they do not reach him using the home telephone number, they either leave a message or make a second call to the cellular number. Using this invention, a single number can be used to reach the user at home or away. When he is at home, he has the convenience of using cordless telephone hand transceivers or handsets, conveniently located about and around the home, while the cellular telephone would be docked to the cordless telephone base station and simultaneously permitting its battery to charge.

### BRIEF SUMMARY OF THE INVENTION

Accordingly, it is an object of the present invention to provide an apparatus that permits the use of a cordless telephone without being connected to a wire line telephone network by connecting to a wireless telephone network, using a portable cellular telephone docked to the cordless telephone base station, which can recharge the cellular telephone battery, and which permits the use of a single telephone number both at home and away. This also helps simplify the telecommunications needs of the user, making it possible to avoid the expense of maintaining both wired land-line and wireless cellular telephone accounts. Use of this invention will reduce the need for multiple telephone numbers, while permitting the use of cordless telephones without the necessity of a wire land-line and enabling the user to relocate a business or residence without changing telephone numbers or incurring telephone company call forwarding charges. The cordless telephone base station and handsets can be configured for multi-lines, so as to accommodate more than one cellular telephone, enabling several family members to dock their individual cellular telephones to the cordless base station, simultaneously, and permitting them to make and receive telephone calls with the cordless handsets using a specified cellular telephone docked to the cordless base station.

### BRIEF DESCRIPTION OF THE SEVERAL VIEWS OF THE DRAWING

FIG. 1 is a block diagram of a cordless telephone base station embodying the present invention integrating connection ports, or docking receptacles, for attaching portable cellular telephones.

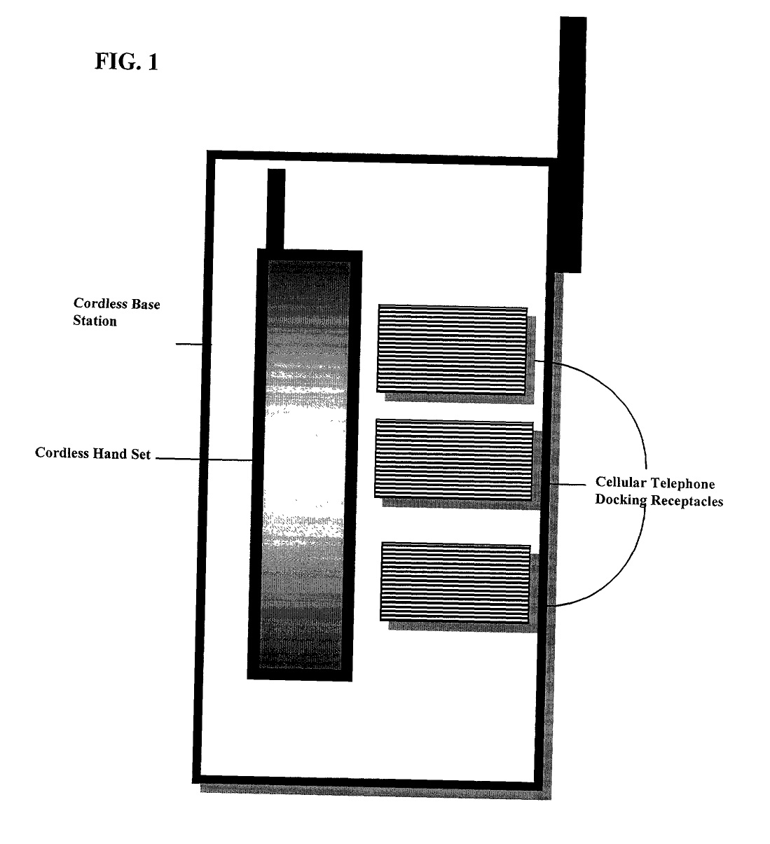

FIG. 2 is a block diagram of a cordless telephone base station with a cellular telephone docked to a receptacle, according to the present invention.

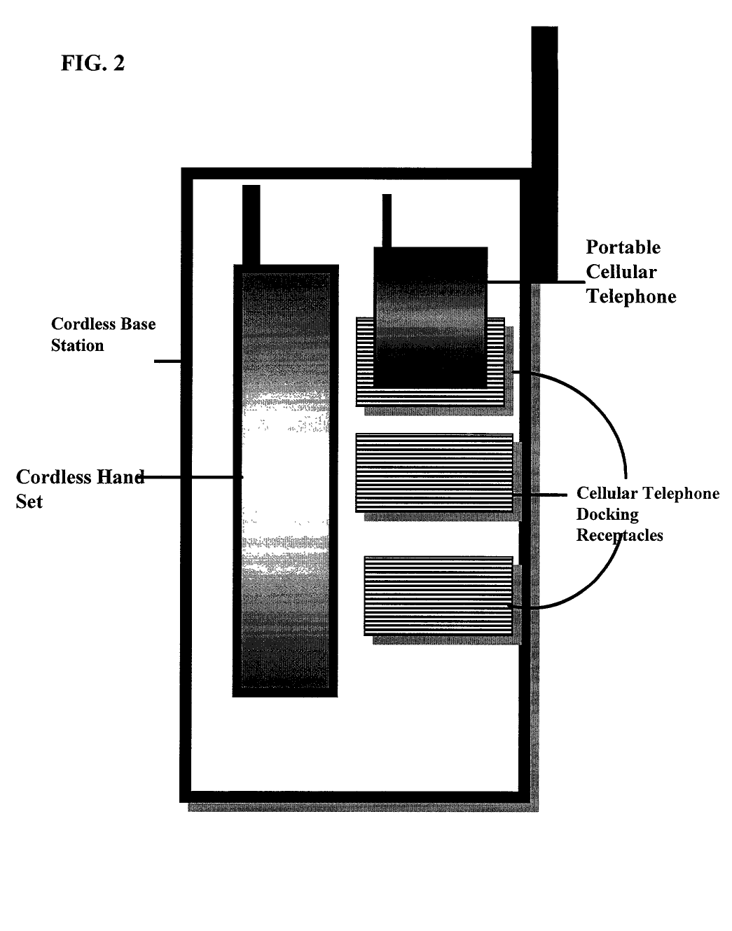

FIG. 3 is a block diagram of a cordless telephone handset including a display and buttons for selecting the particular cellular telephone from several docked to the cordless telephone base station.

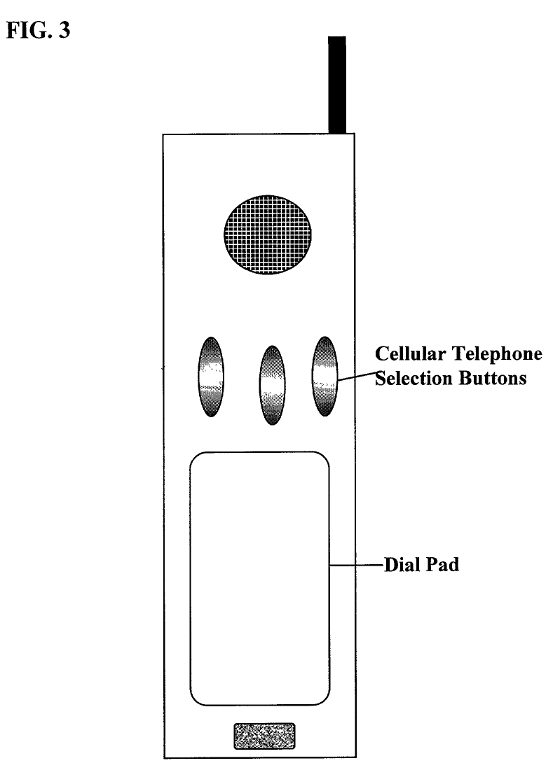

FIG. 4 is a another embodiment of the invention incorporating a high power cellular telephone antenna attached to the cordless telephone base station..

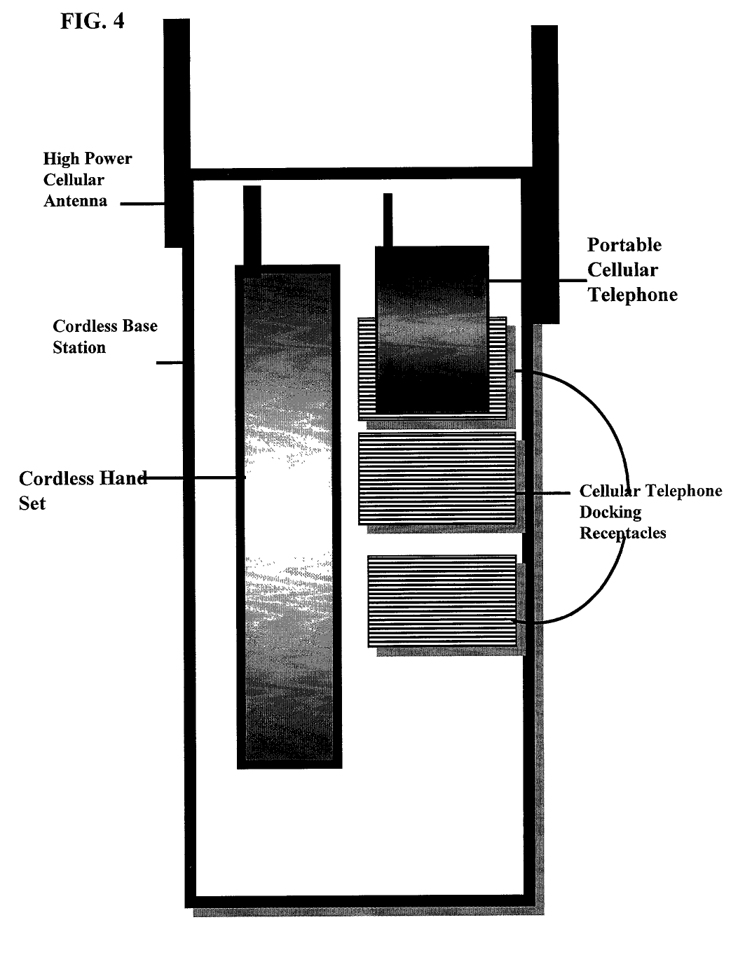

### DETAILED DESCRIPTION OF THE INVENTION

While this invention is susceptible of embodiment in many forms, there is shown in the drawings and will herein be described in detail a preferred embodiment of the invention with the understanding that the present disclosure is to be considered as an exemplification of the principle of the invention and is not intended to limit the broad aspect of the invention to the embodiment illustrated.

The present invention integrates the cordless telephone with the wireless cellular telephone network by permitting a portable cellular telephone to be docked to a cordless telephone base station with a cellular telephone receptacle, so a portable cellular telephone can be attached. The cordless telephone base station communicates with the cordless telephone handset transceiver through the antenna in the usual manner. The cordless telephone base station passes the radio signal between the cordless telephone handset and an attached portable cellular telephone through a processor integrated into the cordless telephone base station which permits the attached portable cellular telephone to transmit and receive to the wireless cellular telephone network through its antenna, or in another embodiment of the invention through a second high power cellular antenna incorporated into the cordless telephone base station, to complete the call. The processor located in the cordless telephone base station accepts and converts the signal from the portable cellular telephone through the connection attaching the portable cellular telephone with the cordless telephone base station for transmission to the cordless telephone handset transceiver using cordless radio signals.

I claim:

1. a cordless telephone for making and receiving telephone calls through the use of either a wireline or wireless cellular telephone network.

2. the cordless telephone system of claim 1 wherein the connection to the cellular wireless network is through the use of a portable cellular telephone attached to a cordless telephone base station having connector means so as to integrate as a single unit with a cellular telephone receptacle, or docking station.

3. the cordless telephone system of claim 1 allowing for multiple portable cellular telephone receptacles, or docking stations.

4. the cordless telephone system of claim 1 incorporating therein a cellular telephone antennae operating at increased power over the antennae already integrated into the portable cellular telephone.

5. the cordless telephone system of claim 1 having the ability to be a hands free speaker phone.

6. the cordless telephone system of claim 1 which will recharge the portable cellular telephone battery while it is docked to the cordless telephone base station.
